(19) United States
(12) Patent Application Publication
(10) Pub. No.: US 2018/0254655 A1
(43) Pub. Date: Sep. 6, 2018

(54) WIRELESS CHARGING APPARATUS

(71) Applicants: LITE-ON ELECTRONICS (GUANGZHOU) LIMITED, Guangzhou (CN); Lite-On Technology Corporation, Taipei (TW)

(72) Inventor: Kuang-Yao Liao, Taipei (TW)

(73) Assignees: LITE-ON ELECTRONICS (GUANGZHOU) LIMITED, GUANGZHOU (CN); Lite-On Technology Corporation, Taipei (TW)

(21) Appl. No.: 15/835,462

(22) Filed: Dec. 8, 2017

(30) Foreign Application Priority Data
Mar. 6, 2017 (CN) 201710128323.2

(51) Int. Cl. H02J 7/02; H02J 50/12; H02J 50/70; H01F 38/14; H01F 27/28; H01F 27/36

(52) U.S. Cl. CPC H02J 7/025; H02J 50/12; H01F 27/365; H01F 38/14; H01F 27/288; H02J 50/70

(57) ABSTRACT

A wireless charging apparatus including a power emitting module and a power transmission module is provided. The power emitting module has a first coil for transmitting a charge power. The power transmission module is electrically coupled to the power emitting module. The power transmission module has second and third coils, where the second coil is coupled to the first coil for receiving the charge power, and the third coil is coupled to the second coil to receive the charge power. Wherein, the third coil is coupled to a portable electrical device, and provides the charge power to charge the portable electrical device.

### CROSS REFERENCE TO RELATED APPLICATION

This application claims the priority benefit of China application serial no. 201710128323.2, filed on Mar. 6, 2017. The entirety of the above-mentioned patent application is hereby incorporated by reference herein and made a part of specification.

### BACKGROUND OF THE INVENTION

### 1. Field of the Invention

The invention generally relates to a wireless charging apparatus, and more particularly, to a wireless charging apparatus capable of enhancing the convenience of use.

### 2. Description of Related Art

In many aspects of daily life, in order to enhance the convenience of use of electronic devices, wireless data access methods have been introduced to resolve the inconvenience caused wired data transmission. However, similar types of simple wireless power source transmission device are still unable to be popularized, resulting in carriages of heavy plug, cable and adapter when going out, and are very inconvenient in use.

In response thereto, a large number of relative wireless charging appliances proposed by known technology have emerged. Nevertheless, conventional wireless charging panels are only suitable for indoor use; and for the use in vehicles (such as cars) or during outdoor activities, currently, there is no better wireless charging solution.

### SUMMARY OF THE INVENTION

The invention is directed to a wireless charging apparatus capable of enhancing the convenience of use.

The wireless charging apparatus of the invention includes a power emitting module and a power transmission module. The power emitting module has a first coil for transmitting a charge power. The power transmission module is electrically coupled to the power emitting module. The power transmission module has a second coil and a third coil, the second coil is coupled to the first coil for receiving the charge power, and the third coil is coupled to the second coil for receiving the charge power. The third coil is coupled to the portable electrical device to transmit the charge power.

In one embodiment of the invention, a first connecting portion is formed at the coupling between the power transmission module and the power emitting module, and the first coil and the second coil perform a magnetic induction operation in the first connecting portion to transmit the charge power.

In one embodiment of the invention, the wireless charging apparatus further includes a relay transmission module. The relay transmission module is connected between the power emitting module and the power transmission module through a second connecting portion and a third connecting portion, respectively, and has a fourth coil and a fifth coil. The fourth coil and the first coil are magnetic inductively coupled in the second connecting portion to transmit the charge power, and the fifth coil and the second coil are magnetic inductively coupled in the third connecting portion to transmit the charge power.

In one embodiment of the invention, the wireless charging apparatus further includes a detection module. The detection module is coupled to at least one of the first coil, the second coil and the third coil for adjusting a resonant inductance of at least one of the first coil, the second coil and the third coil.

In one embodiment of the invention, the detection module includes a detector and a calculator. The detector is coupled to at least one of the first coil, the second coil and the third coil and detects a detection voltage of at least one of the first coil, the second coil and the third coil. The calculator is coupled to the detector and generates a control signal according to the detection voltage so as to correspondingly adjust the resonant inductance of at least one of the first coil, the second coil and the third coil.

In view of the above, the invention provides a wireless charging apparatus with one or more connection nodes. In this way, the wireless charging apparatus of the invention is able to avoid an exposure of wires and provide a wireless charging medium for the portable electronic device under conditions of providing both convenience and aesthetics while improving product water resistance. As a result, the practicality of the wireless charging apparatus is greatly enhanced.

Several exemplary embodiments accompanied with figures are described in detail below to further describe the disclosure in details.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a schematic diagram of a wireless charging apparatus according to an embodiment of the invention.

FIG. 2 illustrates an appearance schematic diagram of the wireless charging apparatus of FIG. 1.

FIG. 3 illustrates a schematic diagram of a wireless charging apparatus according to another embodiment of the invention.

FIG. 4 illustrates a schematic diagram of a wireless charging apparatus according to another embodiment of the invention.

FIG. 5 illustrates a schematic diagram of a wireless charging apparatus according to another embodiment of the invention.

FIG. 6A and FIG. 6B are schematic diagrams illustrating a method of reducing magnetic leakage of a wireless charging apparatus according to embodiments of the invention.

### DESCRIPTION OF THE EMBODIMENTS

Reference will now be made in detail to the preferred embodiments of the invention, examples of which are illustrated in the accompanying drawings. Wherever possible, the same reference numbers are used in the drawings and the description to refer to the same or like parts.

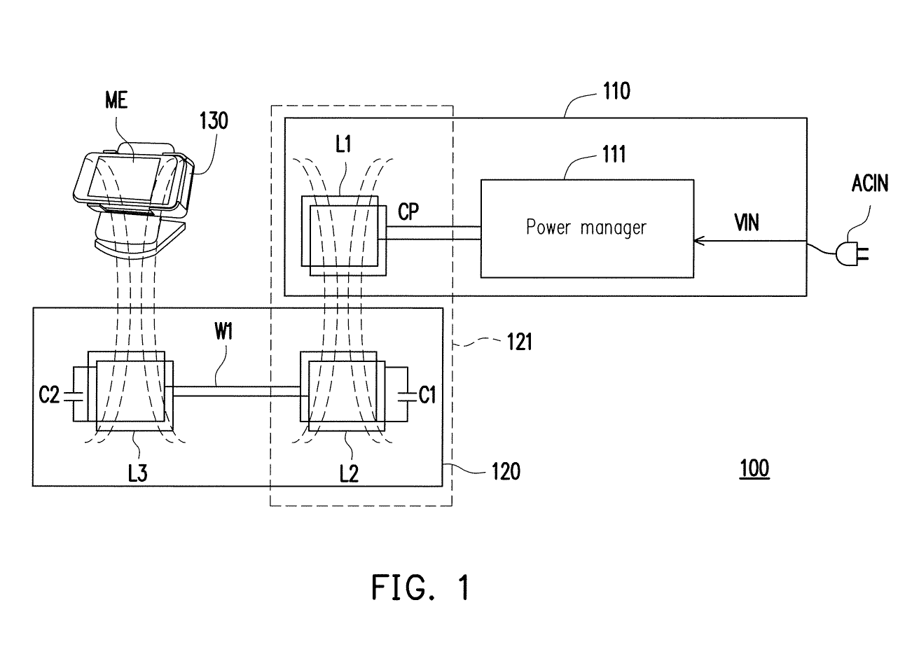

Referring to FIG. 1, which illustrates a schematic diagram of a wireless charging apparatus according to an embodiment of the invention. The wireless charging apparatus 100 includes a power emitting module 110 and a power transmission module 120. The power emitting module 110 includes a coil L1 and a power manager 111. The power manager 111 may receive a power source VIN through the power receiving pin ACIN and generate a charge power CP according to the power source VIN. The coil L1 is coupled to the power manager 111 and receives the charge power CP generated thereby so as to transmit the charge power CP. A connection portion 121 is formed at the coupling between the power transmission module 120 and the power emitting module 110, the power transmission module 120 includes coils L2 and L3, the coils L2 and L3 may be electrically connected with each other through a wire W1, and the coils L1 and L2 are electrically coupled with each other in the connecting portion 121. In the embodiment, the coils L1 to L3 may be magnetic induction coils. In other embodiments, the coils L2 and L3 may also be electrically coupled by means of wireless scheme, such that the coils L2 and L3 may also be electrically coupled by a wireless solution to transmit the charge power CP, and the scope of the invention is not limited thereto.

In the embodiment, the mutual electrical coupling of the coils L1 and L2 may be arranged by overlapping (completely overlapping or partially overlapping) magnetic field transmission surfaces of the coils L1 and L2 with each other.

On the other hand, the coil L2 produces a magnetic induction with the coil L1 so as to couple the charge power CP, and transmits the charge power CP to the coil L3 through the wire W1 (or by the wireless scheme). When it is to charge the portable electrical device ME, the coil L3 may be coupled with a coil (e.g., a magnetic induction coil) built in the portable electrical device ME, and couples the charge power CP into the portable electrical device ME through the magnetic induction, so as to charge a battery in the portable electrical device ME.

In addition, the power transmission module 120 further includes capacitors C1 and C2 therein. The capacitors C1 and C2 are respectively coupled to the coils L2 and L3, and serve as resonant capacitors for performing resonance operations with the coils L2 and L3.

It is noteworthily that, the wireless charging apparatus 100 may further includes a bearing portion 130 and be coupled to the power transmission module 120. The bearing portion 130 is configured to bear the portable electrical device ME, and when the portable electrical device ME is disposed on the bearing portion 130, the magnetic induction coil built in the portable electrical device ME couples with the coil L3, so as to couple the portable electrical device ME with the charge power CP. The coupling method between the bearing portion 130 and the power transmission module 120 may be adaptively in compliance with different user operation environments or requirements, for example, by means of setting direct connection between entities, adding other transmission wires to connect with each other, or using other wireless transmission/module, and the scope of the invention is not limited thereto.

It is to be noted that, in the connecting portion 121 of the embodiment, the coil L1 in the power emitting module 110 and the coil L2 in the power transmission module 120 can be arranged at positions adjacent to each other, so that the power emitting module 110 can be magnetic inductively coupled to the power transmission module 120 in an adjustable manner. Hence, the wireless charging apparatus 100 of the embodiment may be varied according to different postures of a user, and may correspondingly adjust/change relative positions between the power emitting module 110 and the power transmission module 120, so as to ensure that the coils L1 and L2 are close to each other to perform a magnetic induction, thereby maintain a coupling efficiency of the charge power CP while enhancing an operating convenience for the user.

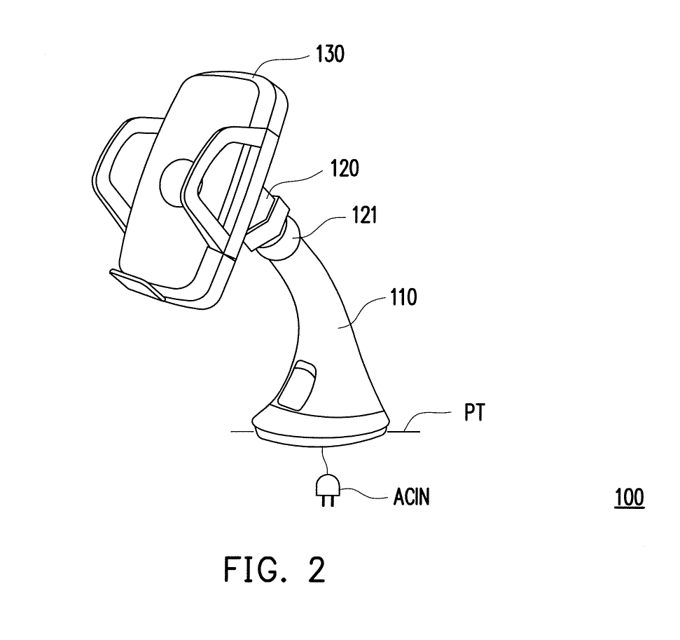

Referring to FIG. 2, which illustrates an appearance schematic diagram of the wireless charging apparatus of FIG. 1. The wireless charging apparatus 100 includes the power emitting module 110, the power transmission module 120 and the bearing portion 130. The power emitting module 110 can be disposed on a platform PT, and a power receiving pin can be disposed under the platform PT. Thus, a power cable of the wireless charging apparatus 100 can be hidden to increase the aesthetics of the wireless charging apparatus 100. Moreover, the power emitting module 110 and the power transmission module 120 can be connected with each other through the adjustable connecting portion 121. Thus, by changing the relative positions between the power emitting module 110 and the power transmission module 120, the user may arbitrarily adjust a relative angle between the bearing portion 130 and the platform PT without influencing the charging efficiency, thereby increasing the convenience of use.

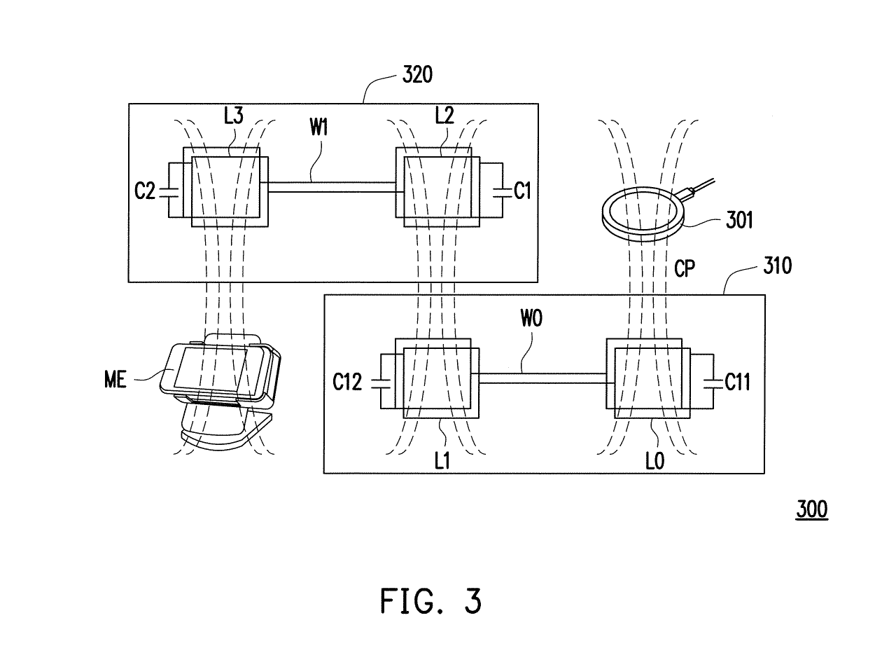

Referring to FIG. 3, which illustrates a schematic diagram of a wireless charging apparatus according to another embodiment of the invention. The wireless charging apparatus 300 includes a power emitting module 310 and a power transmission module 320. The power emitting module 310 includes coils L0 and L1, wherein the coils L0 and L1 may be electrically connected with each other through a wire W0, or may also be electrically coupled with each other through a wireless scheme. The power transmission module 320 includes coils L2 and L3, wherein the coils L2 and L3 may be electrically connected with each other through a wire W1, or may also be electrically coupled with each other through a wireless scheme. In the embodiment, the wireless charging apparatus 300 can be disposed on the wireless charging cradle 301, and enable the coil L0 in the power emitting module 310 to be electrically coupled with the wireless charging cradle 301 to produce a magnetic induction. Thus, a charge power CP generated by the wireless charging cradle 301 may be coupled into the wireless charging apparatus 300 and be transmitted to the portable electrical device ME for power charging. The coils L0 to L3 may be magnetic induction coils.

Incidentally, in the embodiment, the power emitting module 310 further includes capacitors C11 and C12 for respectively coupling to the coils L0 and L1. The capacitors C11 and C12 can respectively serve as resonant capacitors on the coils L0 and L1 for performing resonance operations with the coils L0 and L1.

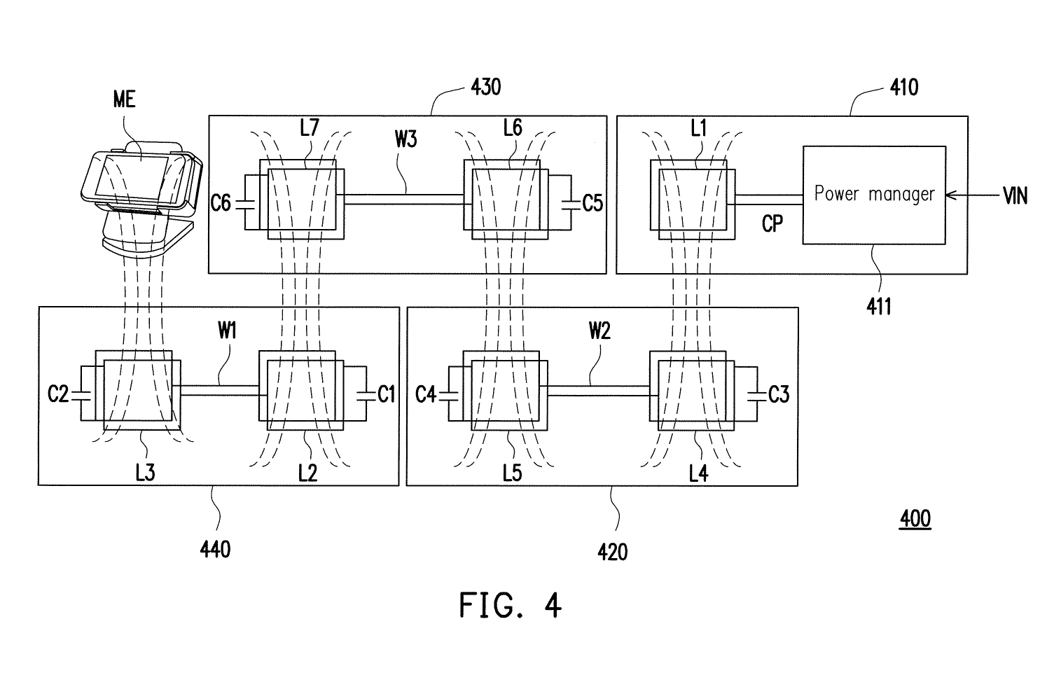

Referring to FIG. 4, which illustrates a schematic diagram of a wireless charging apparatus according to another embodiment of the invention. The wireless charging apparatus 400 includes a power emitting module 410, relay transmission modules 420 and 430, and a power transmission module 440. The power emitting module 410 includes a coil L1 and a power manager 411. The power manager 411 receives a power source VIN and generates the charge power CP. The power manager 411 is coupled to the coil L1 and transmits the charge power CP to the coil L1.

Different from the foregoing embodiments, the embodiment is configured with the relay transmission modules 420 and 430. The relay transmission module 420 includes coils L4 and L5, and the coils L4 and L5 may be electrically connected with each other through a wire W2, or may be electrically coupled with each other by a wireless scheme. The relay transmission module 430 includes coils L6 and L7. The coils L6 and L7 may be electrically connected with each other through a wire W3, or may be electrically coupled with each other by a wireless scheme. Noteworthily, the coils L4 to L7 of the embodiment may be magnetic induction coils, and a connecting portion may be formed at the coupling between the power transmission module 410 and the relay transmission module 420, so that the power emitting module 410 and the relay transmission module 420 can perform a magnetic inductively coupling action in an adjustable manner. Besides, another connecting portion may also be formed at the coupling between the relay transmission module 420 and the relay transmission module 430, so that the relay transmission module 420 and the relay transmission module 430 can also perform a magnetic inductively coupling action in an adjustable manner. Moreover, a connecting portion may also be formed at the coupling between the relay transmission module 430 and the power transmission module 440, such that the relay transmission module 430 and the power transmission module 440 can also perform a magnetic inductively coupling action in an adjustable manner. The coil L1 in the power emitting module 410 and the coil L4 in the relay transmission module 420 are electrically coupled with each other, and the coil L5 in the relay transmission module 420 and the coil L6 in the relay transmission module 430 are electrically coupled with each other.

With the coils L1 and L4 that are electrically coupled to each other, the charge power CP can be electrically coupled to the relay transmission module 420; through the wire W2 (or by means of wireless electrical coupling), the charge power CP can be transmitted to the coil L5. In addition, with the coils L5 and L6 that are electrically coupled to each other, the charge power CP can be electrically coupled to the relay transmission module 430; through the wire W3 (or by means of wireless electrical coupling), the charge power CP can be transmitted to the coil L7.

The power transmission module 440 includes coils L2 and L3. The coils L2 and L3 may be electrically connected with each other through the wire W1, or may be electrically coupled with each other through a wireless scheme. The coil L2 is coupled with the coil L7 of the relay transmission module 430 for coupling the charge voltage CP to the power transmission module 440. Through the wire W1 (or by means of wireless electrical coupling) and the coil L3, the charge voltage CP can be electrically coupled to the portable electrical device ME for charging the portable electrical device ME.

Incidentally, the wireless charging apparatus 400 further includes capacitors C1 to C6 therein. The capacitor C1 to C6 are respectively coupled to the coils L2 to L7, and respectively serve as the resonant capacitors of the coils L2 to L7 for performing resonance operations with the coils L2 to L7.

Especially, in the embodiment, with the disposition of the relay transmission modules 420 and 430, the degree of freedom for the wireless charging apparatus 400 to change in formation can be increased, thereby enhancing the convenience of use.

In other embodiment, the number of relay transmission module may also be adjusted according to the needs of the user, and is not particularly limited. For example, the relay transmission module may be excluded, or may be in a quantity of one or a plurality.

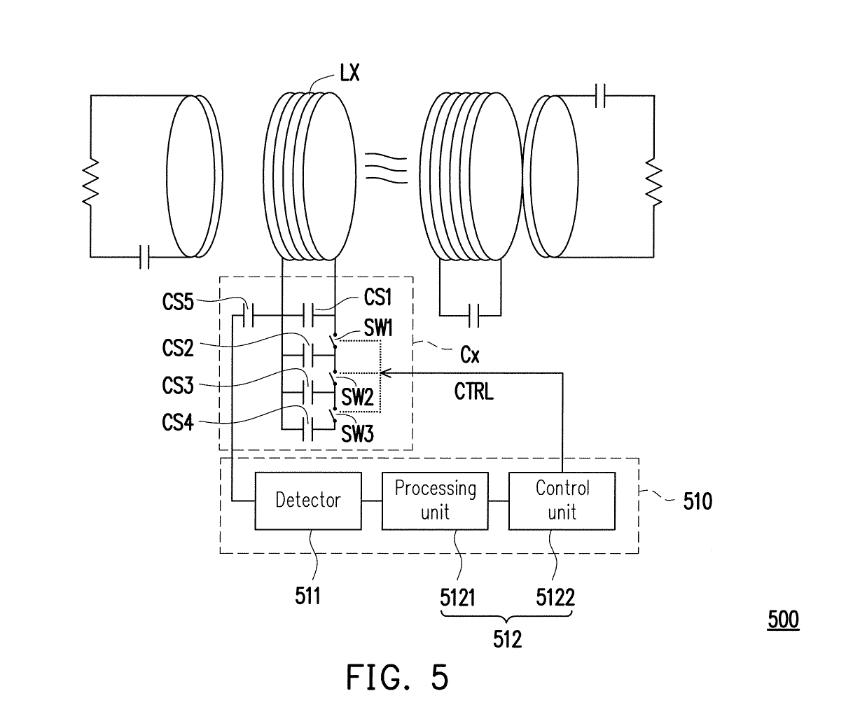

Referring to FIG. 5, which illustrates a schematic diagram of a wireless charging apparatus according to another embodiment of the invention. The wireless charging apparatus 500 is further disposed with a detection module 510 therein for enhancing the charging efficiency. The detection module 510 is coupled to at least one coil Lx in a plurality of coils of the wireless charging apparatus 500, and is configured to adjust a resonant inductance of the coil Lx. The coil Lx is coupled to a variable capacitor Cx, and the variable capacitor Cx may be constituted by a plurality of capacitors and a plurality of switches. By controlling the conduction or the disconnection of each of the switches, a capacitance value of the variable capacitor Cx can be adjusted, thereby adjusting the resonant inductance of the coil Lx.

The detection module 510 includes a detector 511 and a calculator 512. The detector 511 is coupled to the coil Lx and detects a detection voltage on the capacitor Cx, and the calculator 512 calculates a signal transmission strength according to the detection voltage and generates a control signal CTRL according to the signal transmission strength. In one embodiment, the calculator 512 may include a processing unit 5121 and a control unit 5122. The processing unit 5121 is coupled to the detector 511, and the processing unit 5121 receives the detection voltage and calculates the signal transmission strength according to the detection voltage. The control unit 5122 is coupled to the processing unit 5121 and generates the control signal CTRL according to the signal transmission strength, wherein the control signal CTRL is used to adjust a capacitance value of the capacitor Cx.

Specifically, the detector 511 may be a voltage detector, which samples (or filters) a voltage on the capacitor Cx and obtains a voltage value of the capacitor Cx to serve as the detection voltage. The processing unit 5121 may obtain the signal transmission strength in the coil Lx according to the detection voltage. The control unit 5122 may change the capacitance value of the capacitor Cx through the control signal CTRL; in the process of changing the capacitance value of the capacitor Cx, processing unit 5121 may continuously record the changing states of the signal transmission strength and obtain a control signal CTRL corresponding to a preferred signal transmission strength, and enables the control unit 5122 to set a preferred capacitance value for the capacitor Cx through the control signal CTRL.

Moreover, in the embodiment of FIG. 5, the capacitor Cx is designed as a structure of a variable capacitor, wherein the capacitor Cx includes a plurality of sub-capacitors CS1 to CS5 and a plurality of switches SW1 to SW3 therein. Two ends of the sub-capacitor CS1 bridging connect two ends of the coil Lx. First ends of the sub-capacitors CS2 to CS4 are commonly coupled to a first end of the sub-capacitor CS1, and second ends of the sub-capacitors CS2 to CS4 are connected to a second end of the sub-capacitor CS1 respectively through the switches SW1 to SW3. In addition, the sub-capacitor CS5 is connected in series between the first end of the sub-capacitor CS1 and the performance detector 511.

In the embodiment, the switches SW1 to SW3 can respectively be conducted or disconnected based on multiple bits in the control signal CTRL. Through the number of the switches SW1 to SW3 being conducted, the capacitance value of the capacitor Cx can be adjusted, thereby further adjusting the resonant inductance of the coil Lx.

In the above-described embodiment, the number of the switches is not particularly limited, and more switches and corresponding sub-capacitors may be arranged if it is desired to adjust the capacitance value in a greater range. In addition, capacitance values of the sub-capacitors CS2 to CS4 are not particularly limited. If it is desired to have a better adjustment in resolution, then the sub-capacitors CS2 to CS4 with smaller capacitance values may be arranged; relatively, if it is desired to have a faster adjustment speed, then the sub-capacitors CS2 to CS4 with greater capacitance values may be arranged. Moreover, connection relationships between the sub-capacitors CS2 to CS4 and the switches SW1 to SW3 are also not particularly limited to the arrangement shown in FIG. 5. In fact, any design method for the variable capacitor familiar to those skilled in the art may be used to implement the capacitor Cx, and the invention is not limited thereto.

It can be known from the above descriptions, the embodiment of the invention, through monitoring the signal transmission strength of the coil Lx and adjusting the resonant inductance, can effectively maintain the signal transmission strength of the charge power at a preferred condition, thereby effectively enhancing the wireless charging efficiency.

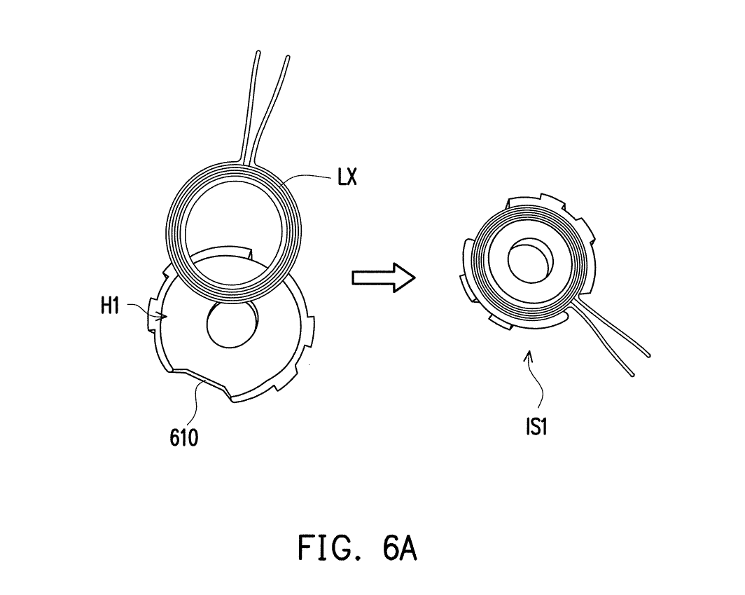

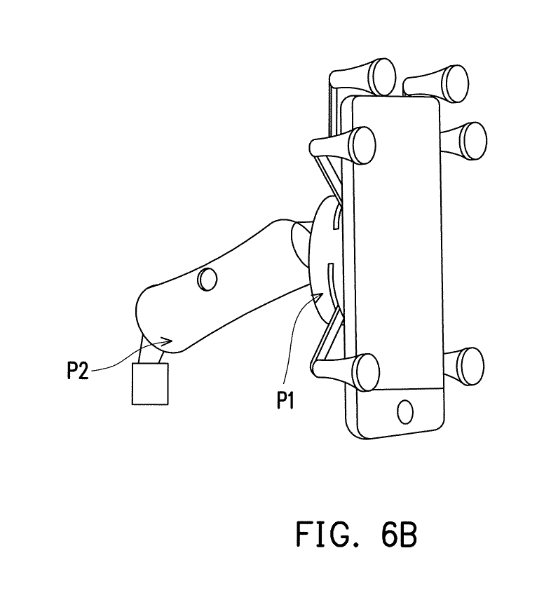

Referring to FIG. 6A and FIG. 6B below, FIG. 6A and FIG. 6B are schematic diagrams illustrating a method of reducing magnetic leakage of a wireless charging apparatus. In FIG. 6A, in order to reduce generation of electromagnetic interference (EMI) due to magnetic leakage and to increase a magnetic induction efficiency between the coils, an anti-magnetic leakage material layer H1 may be disposed on the coil Lx. The anti-magnetic leakage material layer H1 can be disposed according to a coil coupling direction of the coil Lx. The coil Lx and the anti-magnetic leakage material layer H1 corresponded thereto may be disposed in each connecting portion in the embodiment of the invention. In FIG. 6A, the anti-magnetic leakage material layer H1 is laid on a side of a casing 610, and the unidirectional magnetic coil Lx and the anti-magnetic leakage material layer H1 are overlapped with each other to form an integrated structure IS1. This integrated structure can be dispose on positions P1 and P2 of the plurality of connecting portions of the wireless charging apparatus, as shown in FIG. 6B.

In summary, the invention provides the wireless charging apparatus through the power emitting module and the power transmission module connected by the connecting portion. In the embodiments of the invention, through the adjustable connecting portion, the power emitting module can be enhanced in the convenience of use and the aesthetics. Moreover, in the embodiments of the invention, mechanism and method for enhancing the transmission efficiency of the charge power are provided, thereby effectively improving the charging performance of the wireless charging apparatus.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A wireless charging apparatus, comprising:
a power emitting module, having a first coil for transmitting a charge power; and
a power transmission module, electrically coupled to the power emitting module and having a second coil and a third coil, the second coil being coupled to the first coil for receiving the charge power, and the third coil being coupled to the second coil for receiving the charge power;
wherein the third coil is coupled to a portable electrical device to transmit the charge power.

2. The wireless charging apparatus as recited in claim 1, wherein a first connecting portion is formed at the coupling between the power transmission module and the power emitting module, and the first coil and the second coil perform a magnetic induction operation in the first connecting portion to transmit the charge power.

3. The wireless charging apparatus as recited in claim 1, wherein the power transmission module further comprises:
a first capacitor and a second capacitor, respectively coupled to the second coil and the third coil.

4. The wireless charging apparatus as recited in claim 1, further comprising:
a relay transmission module, connected between the power emitting module and the power transmission module through a second connecting portion and a third connecting portion, respectively, and having a fourth coil and a fifth coil, wherein the fourth coil and the first coil are magnetic inductively coupled in the second connecting portion to transmit the charge power, and the fifth coil and the second coil are magnetic inductively coupled in the third connecting portion to transmit the charge power.

5. The wireless charging apparatus as recited in claim 4, wherein the relay transmission module is adjustably connected to the power emitting module through the second connecting portion, the relay transmission module is adjustably connected to the power transmission module through the third connecting portion, and the relay transmission module further comprises:
a third capacitor and a fourth capacitor, respectively coupled to the fourth coil and the fifth coil.

6. The wireless charging apparatus as recited in claim 1, further comprising:
a detection module, coupled to at least one of the first coil, the second coil and the third coil for adjusting a resonant inductance of at least one of the first coil, the second coil and the third coil.

7. The wireless charging apparatus as recited in claim 6, wherein the detection module further comprises:
a detector, coupled to at least one of the first coil, the second coil and the third coil and detecting a detection voltage of at least one of the first coil, the second coil and the third coil; and
a calculator, coupled to the detector and generating a control signal according to the detection voltage so as to correspondingly adjust the resonant inductance of at least one of the first coil, the second coil and the third coil.

8. The wireless charging apparatus as recited in claim 7, wherein at least one of the first coil, the second coil and the third coil is further coupled to a variable capacitor, and the resonant induce is correspondingly adjusted according to the control signal.

9. The wireless charging apparatus as recited in claim 1, further comprising a plurality of anti-magnetic leakage material layers, and the anti-magnetic leakage material layers are respectively coupled to the first coil, the second coil and the third coil according to coil coupling directions of the first coil, the second coil and the third coil, respectively.

10. The wireless charging apparatus as recited in claim 1, further comprising a bearing portion coupled to the power transmission module for bearing the portable electrical device.
